(19) United States
(12) Patent Application Publication
(10) Pub. No.: US 2011/0095989 A1
(43) Pub. Date: Apr. 28, 2011

(54) INTERACTIVE INPUT SYSTEM AND BEZEL THEREFOR

(75) Inventors: Grant McGibney, Calgary (CA); Gregory Forrest, Calgary (CA)

(73) Assignee: SMART Technologies ULC, Calgary (CA)

(21) Appl. No.: 12/604,478

(22) Filed: Oct. 23, 2009

(51) Int. Cl. G06F 3/041; G09G 5/00

(52) U.S. Cl. 345/173; 345/156; 178/18.01

(57) ABSTRACT

An interactive input system comprises at least one imaging device having a field of view looking into a region of interest, a bezel at least partially surrounding the region of interest and having a surface in the field of view of the at least one imaging device, a first radiation source emitting radiation into the region of interact that is generally matched to the characteristics of the bezel so that the radiation emitted by the first radiation source is reflected by the bezel surface generally towards the at least one imaging device and a second radiation source emitting radiation into the region of interest that is generally unmatched to the characteristics of the bezel so that the radiation emitted by the second radiation source is not reflected by the bezel surface.

### FIELD OF THE INVENTION

The present invention relates to an interactive input system and to a bezel therefor.

### BACKGROUND OF THE INVENTION

Interactive input systems that allow users to inject input (e.g. digital ink, mouse events etc.) into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking generally across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Patent Application Publication No. 2004/0179001 to Morrison et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally along the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

In order to determine the type of pointer used to contact the touch surface, in one embodiment a curve of growth method is employed to differentiate between different pointers. During this method, a horizontal intensity profile (HIP) is formed by calculating a sum along each row of pixels in each acquired image thereby to produce a one-dimensional profile having a number of points equal to the row dimension of the acquired image. A curve of growth is then generated from the HIP by forming the cumulative sum from the HIP.

U.S. Pat. No. 7,202,860 to Ogawa discloses a camera-based coordinate input device allowing coordinate input using a pointer or finger. The coordinate input device comprises a pair of cameras positioned in the upper left and upper right corners of a display screen. The field of view of each camera extends to a diagonally opposite corner of the display screen in parallel with the display screen. Infrared emitting diodes are arranged close to the imaging lens of each camera and illuminate the surrounding area of the display screen. An outline frame is provided on three sides of the display screen. A narrow-width retro-reflection tape is arranged near the display screen on the outline frame. A non-reflective reflective black tape is attached to the outline frame along and in contact with the retro-reflection tape. The retro-reflection tape reflects the light from the infrared emitting diodes allowing the reflected light to be picked up as a strong white signal. When a user's finger is placed proximate to the display screen, the finger appears as a shadow over the bright image of the retro-reflection tape.

The video signals from the two cameras are fed to a control circuit, which detects the border between the white image of the retro-reflection tape and the outline frame. A horizontal line of pixels from the white image close to the border is selected. The horizontal line of pixels contains information related to a location where the user's finger is in contact with the display screen. The control circuit determines the coordinates of the touch position, and the coordinate value is then sent to a computer.

When a pen having a retro-reflective tip touches the display screen, the light reflected therefrom is strong enough to be registered as a white signal. The resulting image is not discriminated from the image of the retro-reflection tape. However, the resulting image is easily discriminated from the image of the black tape. In this case, a line of pixels from the black image close to the border of the outline frame is selected. Since the signal of the line of pixels contains information relating to the location where the pen is in contact with the display screen. The control circuit determines the coordinate value of the touch position of the pen and the coordinate value is then sent to the computer.

In the Ogawa coordinate input device, resolution issues can arise if a finger that is illuminated by ambient light and/or by other source light is brought into proximity of the cameras as the finger may appear as bright as or brighter than the retro-reflection tape in images captured by the cameras. In such cases, separating the pointer from the retro-reflection tape in the captured images can provide to be difficult. As will be appreciated, improvements in interactive input systems are sought.

It is therefore an object of the present invention at least to provide a novel interactive input system and a novel bezel therefor.

### SUMMARY OF THE INVENTION

Accordingly, in one aspect there is provided an interactive input system comprising at least one imaging device having a field of view looking into a region of interest; a bezel at least partially surrounding the region of interest and having a surface in the field of view of the at least one imaging device; a first radiation source emitting radiation into the region of interest that is generally matched to the characteristics of the bezel so that the radiation emitted by the first radiation source is reflected by the bezel surface generally towards the at least one imaging device; and a second radiation source emitting radiation into the region of interest that is generally unmatched to the characteristics of the bezel so that the radiation emitted by the second radiation source is not reflected by the bezel surface.

In one embodiment, the interactive input system further comprises a first filter associated with the first radiation source through which radiation emitted by the first radiation source passes and a second filter on the bezel that is matched to the first filter. A third filter is associated with the second radiation source through which radiation emitted by the second radiation source passes. The third filter in unmatched to the first and second filters. Each of the first and second radiation sources comprises a light source. In one embodiment, each light source comprises one or more light emitting diodes. The first and second filters may take the form of polarizing filters having the same axis of polarization. In this case, the third filter is a polarizing filter having an axis of polarization generally orthogonal to the axes of polarization of the first and second filters.

In one embodiment, the interactive input system further comprises processes structure communicating with the at least one imaging device and processing image data output thereby. The processing structure compares image data acquired by the at least one imaging device when the first radiation source is on and the second radiation source is off, with image data acquired by the at least one imaging device when the first radiation source is off and the second radiation source is on. A switching circuit connects alternately the first and second radiation sources to a power source.

According to another aspect there is provided a bezel for an interactive touch surface comprising a reflective surface oriented to reflect radiation toward at least one imaging device and a filter overlying the reflective surface and matched to intermittent radiation emitted across said touch surface.

### BRIEF DESCRIPTION OF THE DRAWINGS

Embodiments will now be described more fully with reference to the accompanying drawings in which:

FIG. 1 is a perspective view of an interactive input system;

FIG. 2 is a front elevation view of the interactive input system of FIG. 1;

FIG. 3 is a block diagram of an imaging assembly forming part of the interactive input system of FIG. 1;

FIG. 4A is a perspective view of an image sensor and radiation sources forming part of the imaging assembly of FIG. 3;

FIG. 4B is a cross-sectional view of FIG. 4A taken along line 4-4;

FIG. 5 is a front elevational view of a portion of a bezel segment forming part of the interactive input system of FIG. 1;

FIG. 6 is a block diagram of a digital signal processor forming part of the interactive input system of FIG. 1;

FIGS. 7A and 7B are image frames captured by the imaging assembly of FIG. 3 in the absence of a pointer;

FIG. 7C is a difference image frame generated from the image frames of FIGS. 7A and 7B;

FIG. 7D shows a plot of normalized intensity values I(x) calculated for pixel columns of the difference image frame of FIG. 7C;

FIGS. 8A and 8B are image frames captured by the imaging assembly of FIG. 3 when a stylus is positioned adjacent to a bezel segment;

FIG. 8C is a difference image frame generated from the image frames of FIGS. 8A and 8B;

FIG. 8D shows a plot of normalized intensity values I(x) calculated for pixel columns of the difference image frame of FIG. 8C;

FIGS. 9A and 9B are image frames captured by the imaging assembly of FIG. 3 when a stylus is positioned proximate an image sensor;

FIG. 9C is a difference image frame generated from the image frames of FIGS. 9A and 9B;

FIG. 9D shows a plot of normalized intensity values I(x) calculated for pixel columns of the difference image frame of FIG. 9C;

FIG. 10 is a side elevational view of a pen tool used in conjunction with the interactive input system of FIG. 1; and

FIGS. 11A and 11B show illumination of a passive pointer and the bezel by radiation emitted by the radiation sources of the imaging assembly of FIG. 3.

### DETAILED DESCRIPTION OF THE EMBODIMENTS

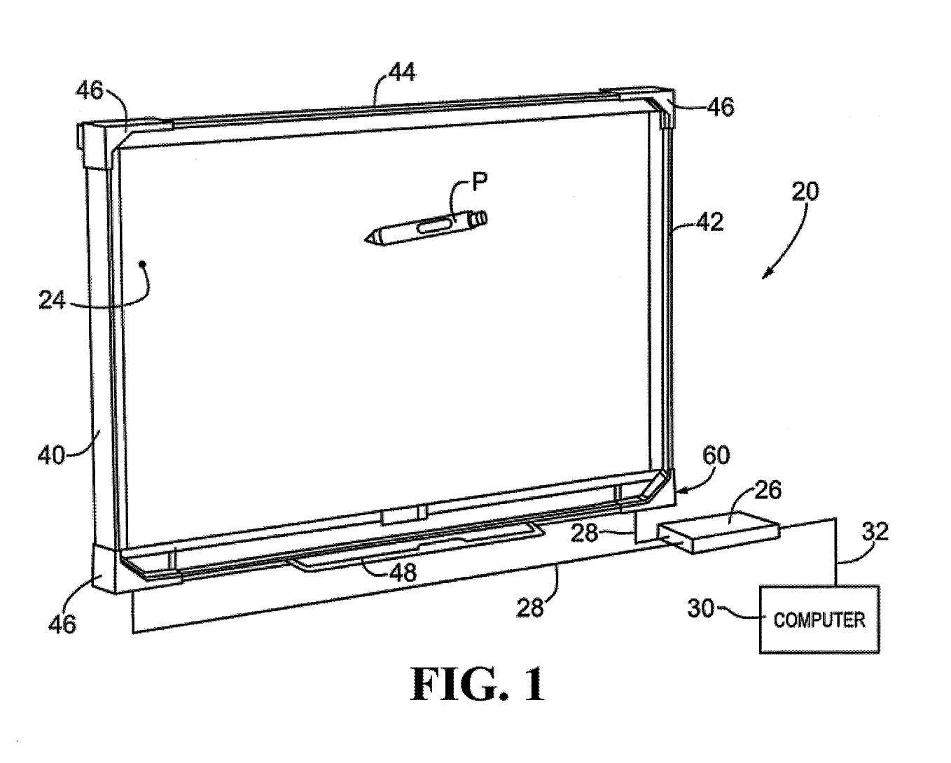

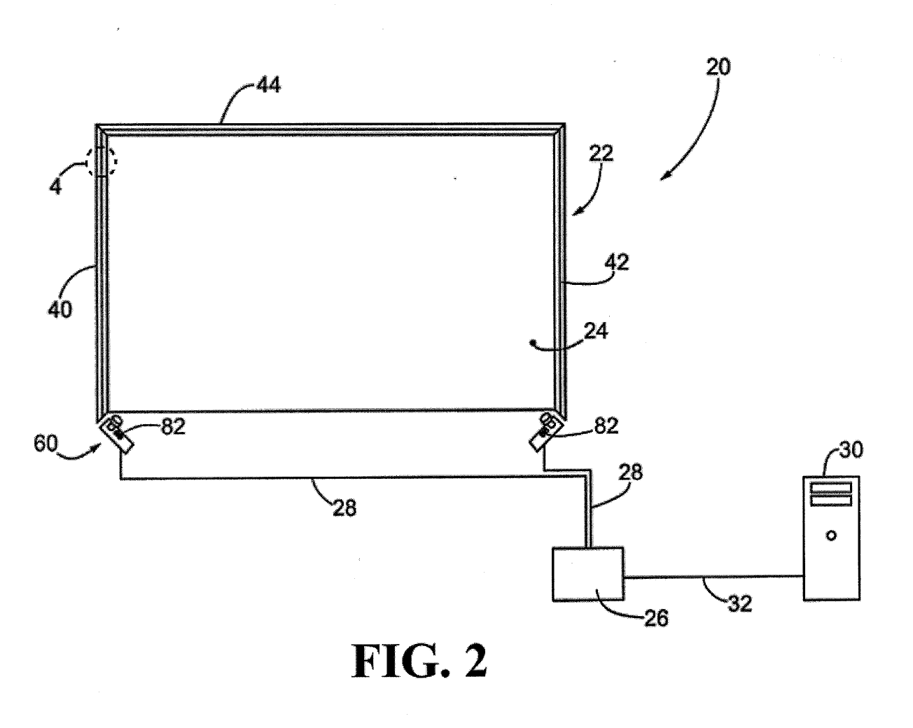

Turning now to FIGS. 1 and 2, an interactive input system that allows a user to inject input such as digital ink, mouse events etc. into an application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube display or monitor etc. and surrounds the display surface 24 of the display unit. The assembly 22 employs machine vision to detect pointers brought into a region of interest in proximity with the display surface 24 and communicates with a digital signal processor (DSP) unit 26 via communication lines 28. The communication lines 28 may be embodied in a serial bus, a parallel bus, a universal serial bus (USB), an Ethernet connection or other suitable wired connection. The DSP unit 26 in turn communicates with a computer 30 executing one or more application programs via a USB cable 32. Alternatively, the DSP unit 26 may communicate with the computer 30 over another wired connection such as for example, a parallel bus, an RS-232 connection, an Ethernet connection etc. or may communicate with the computer 30 over a wireless connection using a suitable wireless protocol such as for example Bluetooth, WiFi, ZigBee, ANT, IEEE 802.15.4, Z-Wave etc. Computer 30 processes the output of the assembly 22 received via the DSP unit 26 and adjusts image data that is output to the display unit so that the image presented on the display surface 24 reflects pointer activity. In this manner, the assembly 22, DSP unit 26 and computer 30 allow pointer activity proximate to the display surface 24 to be recorded as writing or drawing or used to control execution of one or more application programs executed by the computer 30.

Assembly 22 comprises a frame assembly that is mechanically attached to the display unit and surrounds the display surface 24. Frame assembly comprises a bezel having three bezel segments 40, 42 and 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more active pen tools P. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 accommodate imaging assemblies 60 that look generally across the entire display surface 24 from different vantages. The bezel segments 40, 42 and 44 are oriented so that their inwardly facing surfaces are seen by the imaging assemblies 60.

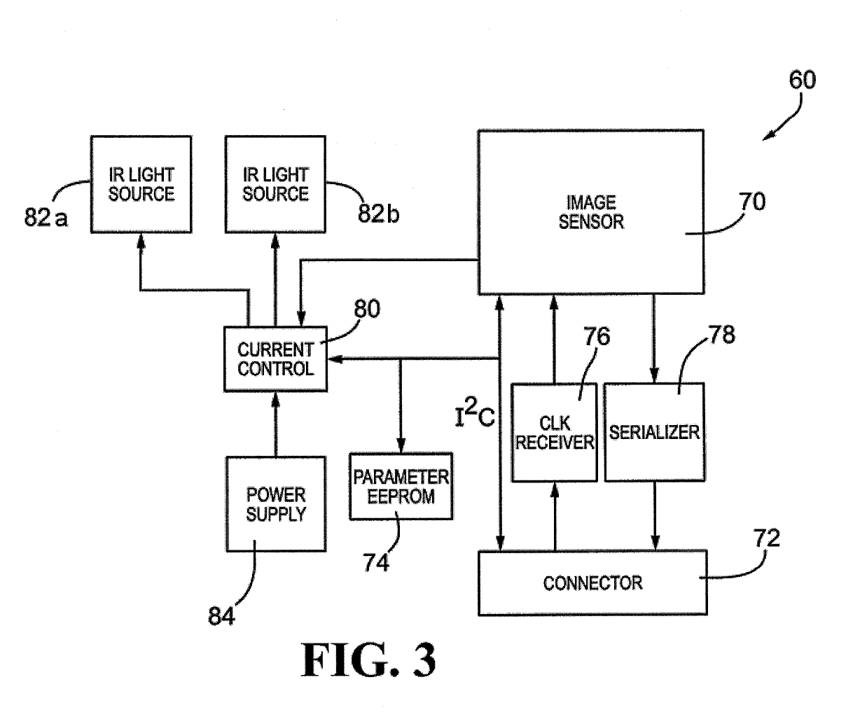

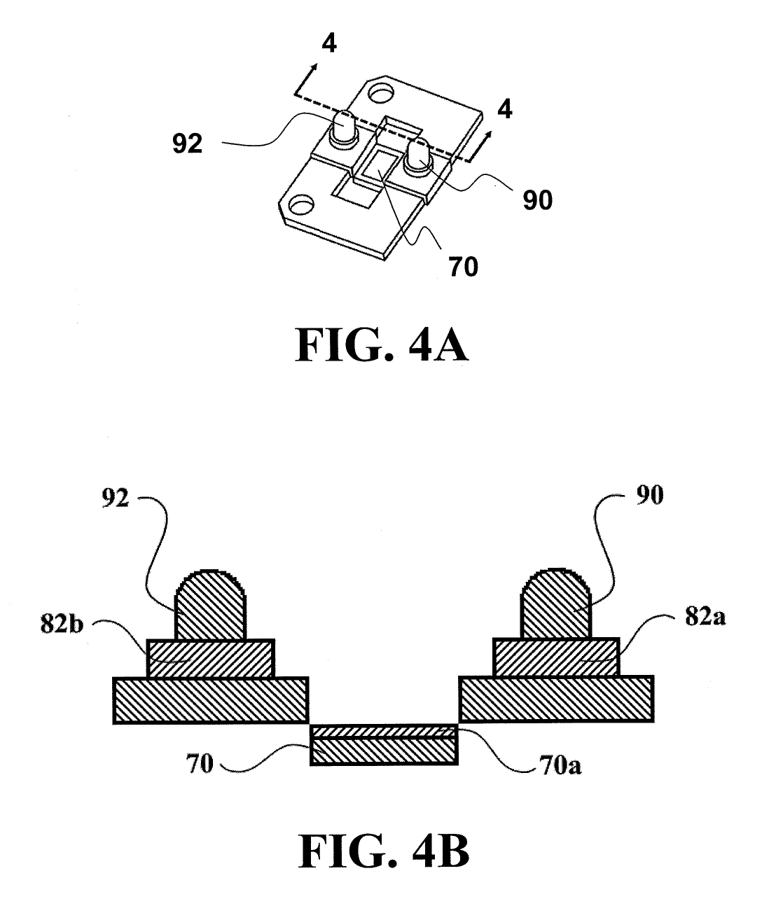

Turning now to FIGS. 3 and 4, one of the imaging assemblies 60 is better illustrated. As can be seen, the imaging assembly 60 comprises an image sensor 70 such as that manufactured by Micron Technology, Inc. of Boise, Id. under model No. MT9V022 fitted with an 880 nm lens of the type manufactured by Boowon Optical Co. Ltd. of Korea under model No. BW25B. The lens has an IR-pass/visible light blocking filter thereon 70a and provides the image sensor 70 with a 98 degree field of view so that the entire display surface 24 is seen by the image sensor 70. The image sensor 70 is connected to a connector 72 that receives one of the communication lines 28 via an I²C serial bus. The image sensor 70 is also connected to an electrically erasable programmable read only memory (EEPROM) 74 that stores image sensor calibration parameters as well as to a clock (CLK) receiver 76, a serializer 78 and a current control module 80. The clock receiver 76 and the serializer 78 are also connected to the connector 72. Current control module 80 is also connected to infrared (IR) light sources 82a and 82b as well as to a power supply 84 and the connector 72. In this embodiment, each IR light source comprises one or more IR light emitting diodes (LEDs). A filter 90 is provided over the IR light source 82a and a filter 92 is provided over IR light source 82b. In this embodiment, the filters 90 and 92 are polarizing filters, with each polarizing filter having a single axis of polarization and with the axis of polarization of filter 90 being generally orthogonal to the axis of polarization of filter 92. The configuration of the LEDs of each IR light source 82 is selected so that the bezel segments 40, 42 and 44 are generally evenly illuminated over their entire lengths. Further specifics concerning the IR light sources 82 are described in U.S. patent application Ser. No. 12/118,552 to Hansen et al. entitled “Interactive Input System And Illumination Assembly Therefor” filed on May 9, 2008 and assigned to SMART Technologies ULC of Calgary, Alberta, the content of which is incorporated herein by reference. Of course, those of skill in the art will appreciate that other types of suitable radiation sources to provide illumination to the region of interest may be used.

The clock receiver 76 and serializer 78 employ low voltage, differential signaling (LVDS) to enable high speed communications with the DSP unit 26 over inexpensive cabling. The clock receiver 76 receives timing information from the DSP unit 26 and provides clock signals to the image sensor 70 that determines the rate at which the image sensor 70 captures and outputs image frames. Each image frame output by the image sensor 70 is serialized by the serializer 78 and output to the DSP unit 26 via the connector 72 and communication lines 28.

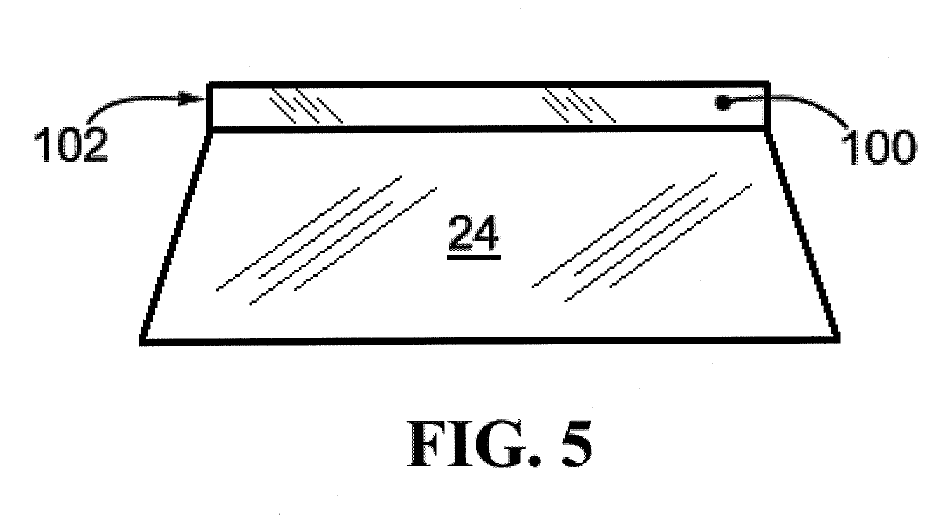

FIG. 5 shows a portion of the inwardly facing surface 100 of one of the bezel segments 40, 42 and 44. As can be seen, the inwardly facing surface 100 of each bezel segment comprises a single horizontal strip or band 102 of retro-reflective material. To take best advantage of the properties of the retro-reflective material, the bezel segments 40, 42 and 44 are oriented so that their inwardly facing surfaces extend in a plane generally normal to that of the display surface 24. A filter (not shown) is also provided on each bezel segment and overlies the retro-reflective band 102. The axis of polarization of the filter over the retro-reflective band 102 of each bezel segment is matched to filter 90 of radiation source 82a. In this manner, IR light emitted by the IR light source 82a that passes through filter 90, passes through the filter over the retro-reflective band 102 of each bezel segment and is reflected by the retro-reflective band 102. IR light emitted by IR light source 82b that passes through filter 92 is blocked by the filter over the retro-reflective band 102 of each bezel segment as a result of the IR light being polarized along an axis orthogonal to the axis of polarization of the filter on the bezel segments 40, 42 and 44.

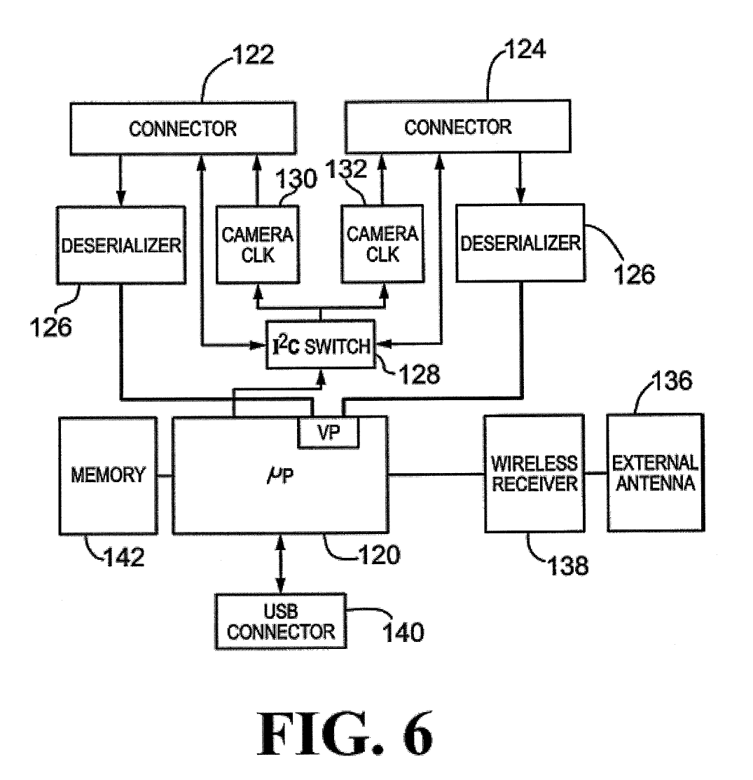

Turning now to FIG. 6, the DSP unit 26 is better illustrated. As can be seen, DSP unit 26 comprises a controller 120 such as for example, a microprocessor, microcontroller, DSP etc. having a video port VP connected to connectors 122 and 124 via deserializers 126. The controller 120 is also connected to each connector 122, 124 via an I²C serial bus switch 128. I²C serial bus switch 128 is connected to clocks 130 and 132, each clock of which is connected to a respective one of the connectors 122, 124. The controller 120 communicates with an external antenna 136 via a wireless receiver 138, a USB connector 140 that receives USB cable 32 and memory 142 including volatile and non-volatile memory. The clocks 130 and 132 and deserializers 126 similarly employ low voltage, differential signaling (LVDS).

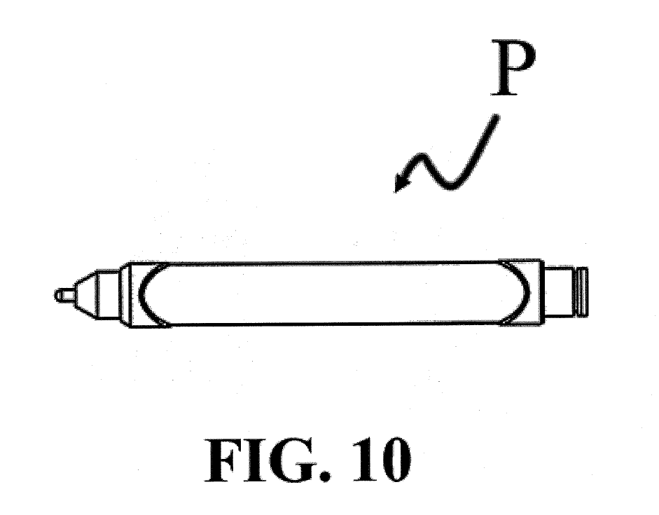

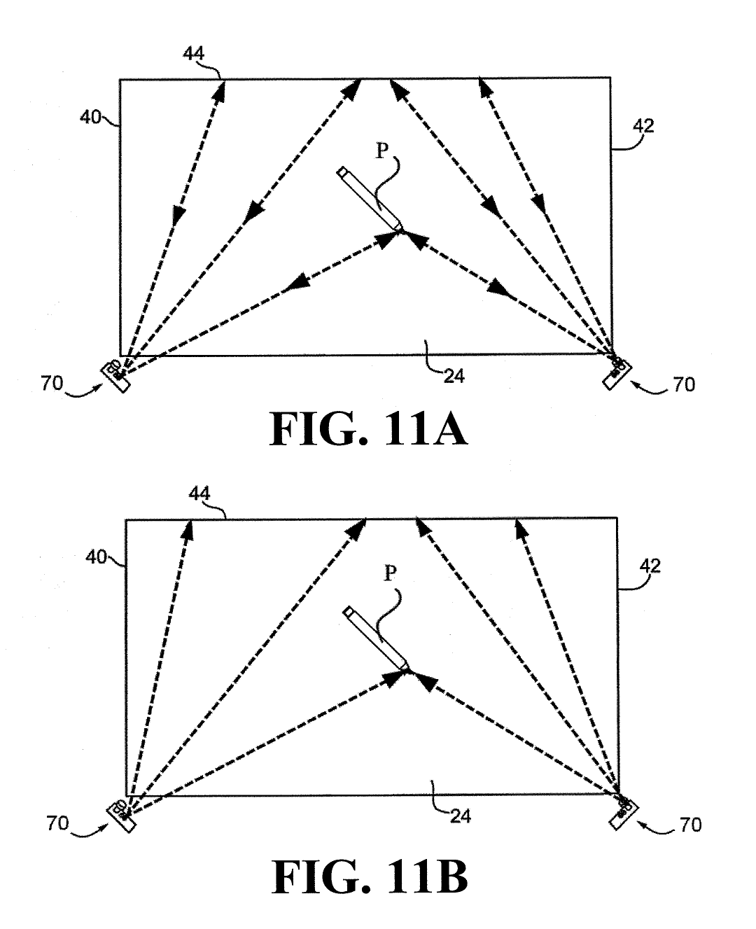

The interactive input system 20 is able to detect passive pointers such as for example, a user's finger, a cylinder or other suitable object as well as active pen tools P as shown in FIG. 10 that are brought into proximity with the display surface 24 and within the fields of view of the imaging assemblies 60. For ease of discussion, the operation of the interactive input system 20, when a passive pointer is brought into proximity with the display surface 24, will be described.

During operation, the controller 120 conditions the clocks 130 and 132 to output clock signals that are conveyed to the imaging assemblies 60 via the communication lines 28. The clock receiver 76 of each imaging assembly 60 uses the clock signals to set the frame rate of the associated image sensor 70. In this embodiment, the controller 120 generates clock signals so that the frame rate of each image sensor 70 is twice the desired image frame output rate. The controller 120 also signals the current control module 80 of each imaging assembly 60 over the I²C serial bus. In response, each current control module 80 initially connects only the IR light source 82a to the power supply 84 and then disconnects the IR light source 82a from the power supply 84 and connects IR light source 82b to the power supply 84. The timing of the on/off IR light source switching is controlled so that for each pair of subsequent image frames captured by each image sensor 70, one image frame is captured when the IR light source 82a is on and one image frame is captured when the IR light source 82b is on.

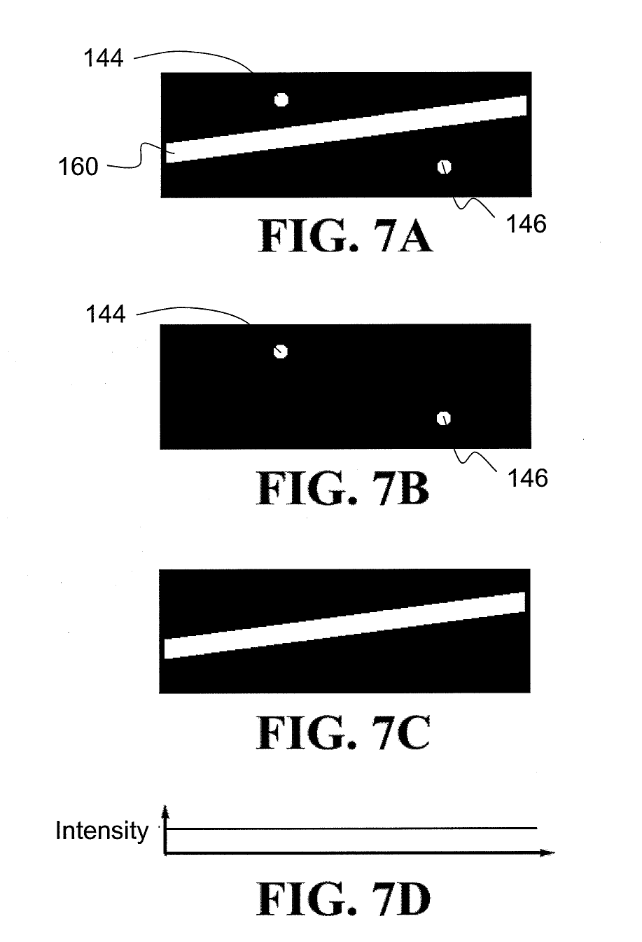

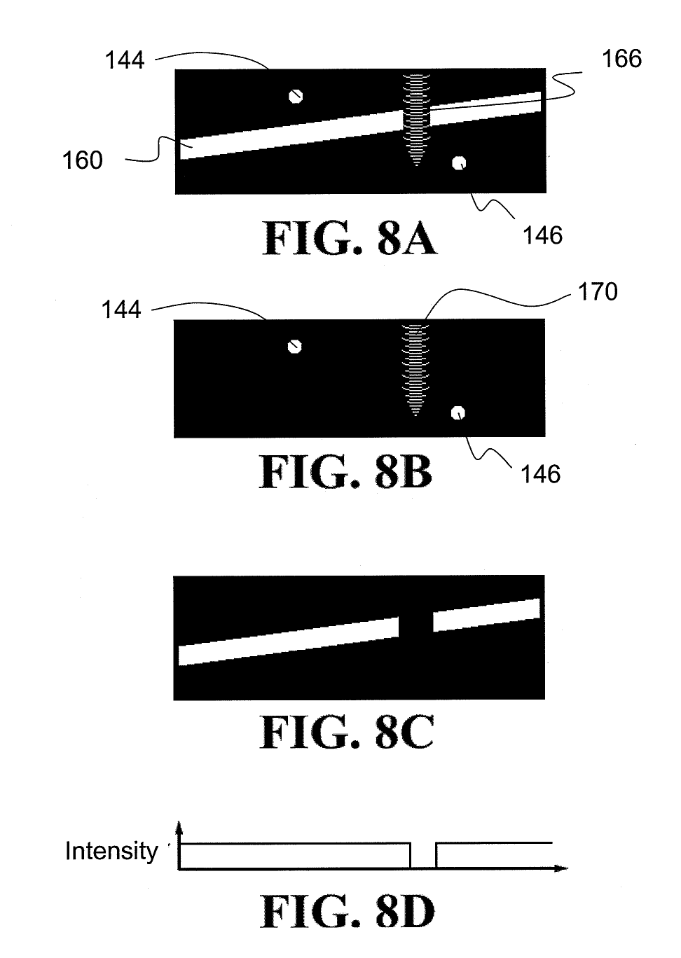

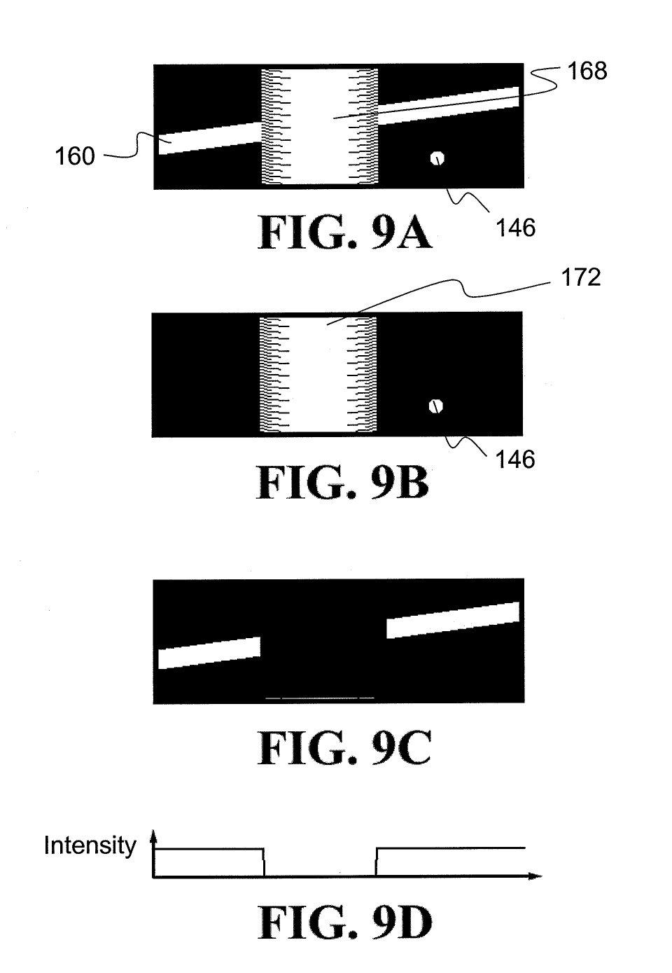

When the IR light sources 82a are on, each LED of the IR light sources 82a floods the region of interest over the display surface 24 with infrared illumination that has been polarized by the filters 90. As the filters 90 are matched to the filters on the bezel segments 40, 42 and 44, the infrared illumination passes through the filters on the bezel segments and impinges on the retro-reflective bands 102. Infrared illumination that impinges on the retro-reflective bands 102 is returned to the imaging assemblies 60. As a result, in the absence of a pointer P, each imaging assembly 60 sees a bright band 160 having a substantially even intensity over its length and possibly ambient light from sources such as the sun, light bulbs, projectors as represented by the white circle 144 above the bright band 160 and/or reflections of ambient light from sources such as the sun, light bulbs, projectors as represented by the white circle 146 below the bright band 160 as shown in FIG. 7A. When a pointer is brought into proximity with the display surface 24 and is sufficiently distant from the IR light sources 82a, the pointer occludes infrared illumination reflected by the retro-reflective bands 102. As a result, each imaging assembly sees a dark region 166 that interrupts the bright band 160 in captured image frames as shown in FIG. 8A. When a pointer P is brought into proximity with the display surface 24 and is sufficiently proximate to an IR light source 82a, the pointer reflects infrared illumination that is returned to the imaging assemblies 60. As a result, the pointer appears as a bright region 168 that crosses the bright band 160 in captured frames as shown in FIG. 9A.

When the IR light sources 82b are on, each LED of the IR light sources 82b floods the region of interest over the display surface 24 with infrared illumination that has been polarized by the filters 92. As the filters 92 are orthogonal (i.e. unmatched) to the filters over the retro-reflective bands 102 of the bezel segments 40, 42 and 44, the infrared illumination is unable to pass through the filters on the bezel segments. As a result, in the absence of a pointer P, the image sensor 70 of each imaging assembly 60 sees darkness and possibly the ambient light and reflections of ambient light as represented by the white circles 144 and 146 as shown in FIG. 7B. When a pointer is brought into proximity with the display surface 24 and is sufficiently distant from the IR light sources 82b, the pointer reflects very little infrared illumination that is returned to the image sensors 70 of the imaging assemblies 60. As a result, the pointer appears a dark region 170 that blends into the dark background in captured image frames as shown in FIG. 8B. When a pointer is brought into proximity with the display surface 24 and is sufficiently proximate to an IR light source 82b, the pointer reflects infrared radiation that is returned to the image sensors 70 of the imaging assemblies 60. As a result, the pointer appears as bright region 172 against the dark background in captured image frames as shown in FIG. 9B.

As mentioned above, each image frame output by the image sensor 70 of each imaging assembly 60 is conveyed to the DSP unit 26. When the DSP unit 26 receives image frames from the imaging assemblies 60, the controller 120 processes the image frames to detect the existence of a pointer therein and if a pointer exists, to determine the position of the pointer relative to the display surface 24 using triangulation. To reduce the effects unwanted light may have on pointer discrimination, the controller 120 measures the difference in the intensity of light within the image frames to detect the existence of a pointer. There are generally three sources of unwanted light, namely ambient light, light from the display unit and infrared illumination that is emitted by the IR light sources 82 and scattered off of objects proximate to the imaging assemblies 60. As will be appreciated, if a pointer is close to an imaging assembly 60, infrared illumination emitted by the associated IR light source 82a may illuminate the pointer directly resulting in the pointer being as bright as or brighter than the retro-reflective bands 102 in captured image frames. As a result, the pointer will not appear in the image frames as a dark region interrupting the bright band 160 but rather will appear as a bright region 168 that extends across the bright band 160 as shown in FIG. 9A.

The controller 120 processes successive image frames output by the image sensor 70 of each imaging assembly 60 in pairs with one image frame captured with IR light source 82a on and the other image frame captured with IR light source 82b on. When the first image frame of a pair is received, the controller 120 stores the image frame in a buffer. When the successive image frame of the pair is received, the controller 120 similarly stores the image frame in a buffer. With the successive image frames available, the controller 120 subtracts the two image frames to form a difference image frame. Provided the frame rates of the image sensors 70 are high enough, ambient light levels and display unit light levels in successive image frames will typically not change significantly and as a result, ambient light and display unit light are substantially cancelled out and do not appear in the difference image frame. The end result is a high contrast image of the pointer and the retro-reflective band 102. Once the difference image frame has been generated, the controller 120 examines the intensity of the difference image frame for values that represent the bezel and the pointer. When no pointer is in proximity with the display surface 24, the intensity values are high and uninterrupted. When a pointer is in proximity with the display surface 24, some of the intensity values fall below a threshold value allowing the existence of the pointer in the difference image frame to be readily determined. In order to generate the intensity values for each difference image frame, the controller 120 calculates a vertical intensity profile (VIPᵣₑₜᵣₒ) for each pixel column of the difference image frame.

FIG. 7C shows a difference image frame generated from the image frames of FIGS. 7A and 7B and FIG. 7D shows a plot of the normalized intensity values I(x) calculated for the pixel columns of the difference image frame of FIG. 7C. As will be appreciated, in this difference image frame no pointer exists and thus, the intensity values I(x) remain high and uninterrupted for all of the pixel columns of the difference image frame. FIG. 8C shows a difference image frame generated from the image frames of FIGS. 8A and 8B and FIG. 8D shows a plot of the normalized intensity values I(x) calculated for the pixel columns of the difference image frame of FIG. 8C. As can be seen, the I(x) curves drop to low values at a region corresponding to the location of the pointer in the difference image frame. FIG. 9C shows a difference image frame generated from the image frames of FIGS. 9A and 9B and FIG. 9D shows a plot of the normalized intensity values I(x) calculated for the pixel columns of the difference image frame of FIG. 9C. As can be seen, the I(x) curves also drop to low values at a region corresponding to the location of the pointer in the difference image frame.

Once the intensity values I(x) for the pixel columns of each difference image frame have been determined, the resultant I(x) curve for each difference image frame is examined to determine if the I(x) curve falls below a threshold value signifying the existence of a pointer and if so, to detect left and right edges in the I(x) curve that represent opposite sides of a pointer. In particular, in order to locate left and right edges in each difference image frame, the first derivative of the I(x) curve is computed to form a gradient curve ∇I(x). If the I(x) curve drops below the threshold value signifying the existence of a pointer, the resultant gradient curve ∇I(x) will include a region bounded by a negative peak and a positive peak representing the edges formed by the dip in the I(x) curve. In order to detect the peaks and hence the boundaries of the region, the gradient curve ∇I(x) is subjected to an edge detector.

In particular, a threshold T is first applied to the gradient curve ∇I(x) so that, for each position x, if the absolute value of the gradient curve ∇I(x) is less than the threshold, that value of the gradient curve ∇I(x) is set to zero as expressed by:

∇I(x)=0, if |∇I(x)|<T

Following the thresholding procedure, the thresholded gradient curve ∇I(x) contains a negative spike and a positive spike corresponding to the left edge and the right edge representing the opposite sides of the pointer, and is zero elsewhere. The left and right edges, respectively, are then detected from the two non-zero spikes of the thresholded gradient curve ∇I(x). To calculate the left edge, the centroid distance CD_{left} is calculated from the left spike of the thresholded gradient curve ∇I(x) starting from the pixel column X_{left} according to:

$${CD}_{left} = \frac{{\sum }_{i} ( {x}_{i} - {X}_{left} ) ∇ I ( {x}_{i} )}{{\sum }_{i} ∇ I ( {x}_{i} )}$$

where xᵢ is the pixel column number of the i-th pixel column in the left spike of the gradient curve ∇I(x), i is iterated from 1 to the width of the left spike of the thresholded gradient curve ∇I(x) and X_{left} is the pixel column associated with a value along the gradient curve ∇I(x) whose value differs from zero (0) by a threshold value determined empirically based on system noise. The left edge in the thresholded gradient curve ∇I(x) is then determined to be equal to X_{left}+CD_{left}.

To calculate the right edge, the centroid distance CD_{right} is calculated from the right spike of the thresholded gradient curve ∇I(x) starting from the pixel column X_{right} according to:

$${CD}_{right} = \frac{{\sum }_{j} ( {x}_{i} - {X}_{right} ) ∇ I ( {x}_{j} )}{{\sum }_{j} ∇ I ( {x}_{j} )}$$

where xᵢ is the pixel column number of the j-th pixel column in the right spike of the thresholded gradient curve ∇I(x), j is iterated from 1 to the width of the right spike of the thresholded gradient curve ∇I(x) and X_{right} is the pixel column associated with a value along the gradient curve ∇I(x) whose value differs from zero (0) by a threshold value determined empirically based on system noise. The right edge in the thresholded gradient curve is then determined to be equal to X_{right}+CD_{right}.

Once the left and right edges of the thresholded gradient curve ∇I(x) are calculated, the midpoint between the identified left and right edges is then calculated thereby to determine the location of the pointer in the difference image frame.

After the location of the pointer in each difference frame has been determined, the controller 120 uses the pointer positions in the difference image frames to calculate the position of the pointer in (x,y) coordinates relative to the display surface 24 using well known triangulation such as that described in above-incorporated U.S. Pat. No. 6,803,906 to Morrison et al. The calculated pointer coordinate is then conveyed by the controller 120 to the computer 30 via the USB cable 32. The computer 30 in turn processes the received pointer coordinate and updates the image output provided to the display unit, if required, so that the image presented on the display surface 24 reflects the pointer activity. In this manner, pointer interaction with the display surface 24 can be recorded as writing or drawing or used to control execution of one or more application programs running on the computer 30.

If desired, as the image frames captured when the IR light sources 82b are on, include image data relating only to the pointer and not the bezel segments 40 to 44, these image frames can be separately analyzed to extract additional information concerning the pointer. For example, these image frames can be analyzed to verify display surface pointer contact and/or to recognize surface features of the pointer to determine the pointer type or in the case of multi-touch scenarios to disambiguate multiple pointers in contact with the display surface 24.

When the active pointer P is brought into proximity with the display surface 24, the IR light sources remain off so that the imaging assemblies see the pointer P as a bright region interrupting a dark band.

To reduce the amount of data to be processed, only the area of the image frames occupied by the bezel segments need be processed. A bezel finding procedure similar to that described in U.S. patent application Ser. No. 12/118,545 to Hansen et al. entitled “Interactive Input System and Bezel Therefor” filed on May 9, 2008 and assigned to SMART Technologies ULC of Calgary, Alberta, the content of which is incorporated herein by reference, may be employed to locate the bezel segments in captured image frames. Of course, those of skill in the art will appreciate that other suitable techniques may be employed to locate the bezel segments in captured image frames.

Although the use of polarizing filters associated with the IR light sources 82a and 82b and bezel segments 40, 42 and 44 has been described, those of skill in the art will appreciate that other types of filters can be used so that radiation emitted by the IR light sources 82a is reflected by the retro-reflective bands 102 and radiation emitted by the IR light sources 82b is blocked by the filter over the retro-reflective band of each bezel segment. For example, if a non-colored pointer (i.e. a white or grey pointer) that reflects radiation emitted by IR light sources 82a and 82b is used, different colored filters can be used with the IR light sources with the filters over the bezel segments being the same color as one of the filters associated with the light sources.

In an alternative embodiment, the IR light sources 82a and 82b are selected to emit radiation at different wavelengths in the visible or non-visible spectrum. For example, the IR light sources 82a may emit radiation at a wavelength of 850 nm and the IR light sources 82b may emit radiation at a wavelength of 880 nm. An IR filter is provided on the bezel segments 40, 42 and 44 that blocks the emitted radiation at wavelength 850 nm and that allows the emitted radiation at wavelength 880 nm to pass. An IR filter on the lens of each image sensor is matched to the emitted radiation at both wavelengths.

If desired, the IR light sources 82 can be further modulated as described in U.S. patent application Ser. No. 12/118,521 to McReynolds et al. entitled “Interactive Input System with Controlled Lighting” filed on May 9, 2008 and assigned to SMART Technologies ULC of Calgary, Alberta, the content of which is incorporated by reference. In this manner, image frames for each imaging assembly based only on the contribution of illumination from its associated IR light source can be generated. The modulated signals output by the pen tool P can also be modulated.

Although specific embodiments have been described above with reference to the figures, those of skill in the art will appreciate that other alternatives are available. For example, in the above embodiment, the DSP unit 26 is shown as comprising an antenna 136 and a wireless receiver 138 to receive the modulated signals output by the pen tool P. Alternatively, each imaging assembly 60 can be provided with an antenna and a wireless receiver to receive the modulated signals output by the pen tool P. In this case, modulated signals received by the imaging assemblies are sent to the DSP unit 26 together with the image frames. The pen tool P may also be tethered to the assembly 22 or DSP unit 26 allowing the signals output by the pen tool P to be conveyed to one or more of the imaging assemblies 60 or the DSP unit 26 or imaging assembly(s) over a wired connection.

In the above embodiments, each bezel segment 40, 42 and 44 is shown as comprising a single retro-reflective band. Those of skill in the art will appreciate that alternatives are available. For example, rather than using a retro-reflective band, a band formed of highly reflective material such as a micro-mirror array may be used. Alternatively, each bezel segment may comprise two or more retro-reflective bands and two or more filters covering the retro-reflective bands.

If desired the tilt of each bezel segment can be adjusted to control the amount of light reflected by the display surface itself and subsequently toward the image sensors 70 of the imaging assemblies 60.

Although the frame assembly is described as being attached to the display unit, those of skill in the art will appreciate that the frame assembly may take other configurations. For example, the frame assembly may be integral with the bezel 38. If desired, the assembly 22 may comprise its own panel to overlie the display surface 24. In this case it is preferred that the panel be formed of substantially transparent material so that the image presented on the display surface 24 is clearly visible through the panel. The assembly can of course be used with a front or rear projection device and surround a substrate on which the computer-generated image is projected.

Although the imaging assemblies are described as being accommodated by the corner pieces adjacent the bottom corners of the display surface, those of skill in the art will appreciate that the imaging assemblies may be placed at different locations relative to the display surface. Also, the tool tray segment is not required and may be replaced with a bezel segment.

Those of skill in the art will appreciate that although the operation of the interactive input system 20 has been described with reference to a single pointer or pen tool P being positioned in proximity with the display surface 24, the interactive input system 20 is capable of detecting the existence of multiple pointers/pen tools that are proximate to the touch surface as each pointer appears in the image frames captured by the image sensors.

Although preferred embodiments have been described, those of skill in the art will appreciate that variations and modifications may be made with departing from the spirit and scope thereof as defined by the appended claims.

What is claimed is:

1. An interactive input system comprising:
at least one imaging device having a field of view looking into a region of interest;
a bezel at least partially surrounding said region of interest and having a surface in the field of view of said at least one imaging device;
a first radiation source emitting radiation into said region of interact that is generally matched to the characteristics of said bezel so that the radiation emitted by said first radiation source is reflected by the bezel surface generally towards said at least one imaging device; and
a second radiation source emitting radiation into said region of interest that is generally unmatched to the characteristics of said bezel so that the radiation emitted by said second radiation source is not reflected by said bezel surface.

2. An interactive input system according to claim 1 further comprising a first filter associated with said first radiation source through which radiation emitted by said first radiation source passes and a second filter on said bezel that is matched to said first filter.

3. An interactive input system according to claim 2 further comprising a third filter associated with said second radiation source through which radiation emitted by said second radiation source passes, said third filter being unmatched to said first and second filters.

4. An interactive input system according to claim 3 wherein each of said first and second radiation sources comprises a light source.

5. An interactive input system according to claim 4 wherein each light source comprises one or more light emitting diodes (LEDs).

6. An interactive input system according to claim 5 wherein each LED is an infrared LED.

7. An interactive input system according to claim 4 wherein each light source is positioned adjacent said at least one imaging device.

8. An interactive input system according to claim 7 wherein each light source comprise one or more LEDs.

9. An interactive input system according to claim 8 wherein each LED is an infrared LED.

10. An interactive input system according to claim 7 wherein said first and second filters are polarizing filters having the same axis of polarization and wherein said third filter is a polarizing filter having an axis of polarization generally orthogonal to the axes of polarization of said first and second filters.

11. An interactive input system according to claim 10 wherein said bezel surface comprises retro-reflective material, said second filter overlying said retro-reflective material.

12. An interactive input system according to claim 11 wherein each light source is comprises one or more LEDs.

13. An interactive input system according to claim 12 wherein each LED is an infrared LED.

14. An interactive input system according to claim 7 wherein said first and second filters are infrared filters passing radiation of the same wavelength and wherein said third filter is an infrared filter passing radiation of a wavelength that is different than the same wavelength.

15. An interactive system according to claim 14 wherein said bezel comprises retro-reflective material and wherein said second filter overlies said retro-reflective material.

16. An interactive input system according to claim 1 further comprising processing structure communicating with said at least one imaging device and processing image data output thereby.

17. An interactive input system according to claim 16 wherein said processing structure compares image data acquired by said at least one imaging device when said first radiation source is on and said second radiation source is off with image data acquired by said at least one imaging device when said first radiation source is off and said second radiation source is on.

18. An interactive input system according to claim 17 further comprising a switching circuit to connect alternately said first and second radiation sources to a power source.

19. An interactive input system according to claim 18 further comprising a first filter associated with said first radiation source through which radiation emitted by said first radiation source passes and a second filter on said bezel that is matched to said first filter.

20. An interactive input system according to claim 19 further comprising a third filter associated with said second radiation source through which radiation emitted by said second radiation source passes, said third filter being unmatched to said first and second filters.

21. An interactive input system according to claim 20 wherein each of said first and second radiation sources comprises a light source.

22. An interactive input system according to claim 21 wherein each light source comprises one or more LEDs.

23. An interactive input system according to claim 20 wherein each light source is positioned adjacent said at least one imaging device.

24. An interactive input system according to claim 23 wherein said first and second filters are polarizing filters having the same axis of polarization and wherein said third filter is a polarizing filter having an axis of polarization generally orthogonal to the axes of polarization of said first and second filters.

25. An interactive input system according to claim 24 wherein said bezel surface comprises retro-reflective material, said second filter overlying said retro-reflective material.

26. An interactive input system according to claim 18 wherein said region of interest is generally rectangular and wherein said bezel extends along multiple sides of said region of interest.

27. An interactive input system according to claim 26 wherein said bezel extends along three sides of said region of interest.

28. An interactive input system according to claim 26 comprising at least two imaging devices looking into said region of interest from different vantages and having overlapping fields of view.

29. An interactive input system according to claim 28 comprising a first radiation sources and a second radiation source proximate each imaging device.

30. An interactive input system according to claim 29 further comprising a first filter associated with said first radiation source through which radiation emitted by said first radiation source passes and a second filter on said bezel that is matched to said first filter.

31. An interactive input system according to claim 30 further comprising a third filter associated with said second radiation source through which radiation emitted by said second radiation source passes, said third filter being unmatched to said first and second filters.

32. An interactive input system according to claim 31 wherein each of said first and second radiation sources comprises a light source.

33. An interactive input system according to claim 32 wherein each light source comprises one or more LEDs.

34. An interactive input system according to claim 31 wherein said first and second filters are polarizing filters having the same axis of polarization and wherein said third filter is a polarizing filter having an axis of polarization generally orthogonal to the axes of polarization of said first and second filters.

35. A bezel for an interactive touch surface comprising a reflective surface oriented to reflect radiation toward at least one imaging device and a filter overlying the reflective surface and matched to intermittent radiation emitted across said touch surface.

36. A bezel according to claim 35 wherein said reflective surface is a retro-reflective surface and wherein said filter is a polarizing filter.

37. A bezel according to claim 35 wherein said reflective surface is a retro-reflective surface.
